(19) United States
(12) Patent Application Publication
(10) Pub. No.: US 2013/0236269 A1
(43) Pub. Date: Sep. 12, 2013

(54) BOOKBINDING CONTROL DEVICE, NON-TRANSITORY COMPUTER READABLE MEDIUM, BOOKBINDING SYSTEM, AND BOOKBINDING CONTROL METHOD

(71) Applicant: Satoshi WATANABE, Kanagawa (JP)

(72) Inventor: Satoshi WATANABE, Kanagawa (JP)

(73) Assignee: FUJI XEROX CO., LTD., Tokyo (JP)

(21) Appl. No.: 13/557,772

(22) Filed: Jul. 25, 2012

(30) Foreign Application Priority Data
Mar. 8, 2012 (JP) 2012-052347

(51) Int. Cl. B42C 13/00

(52) U.S. Cl. 412/11

(57) ABSTRACT

A bookbinding control device includes an acquisition unit that acquires print data including post-processing unnecessary pages and post-processing necessary pages, a printing controller that, after post-processed sheets on which post-processing is performed on sheets with the printed post-processing necessary pages are supplied to a sheet feed unit, prints the post-processing unnecessary pages in print data, a first transport controller that performs control so as to transport sheets with the printed post-processing unnecessary pages to an accumulation unit of a bookbinding device, a second transport controller that performs control so as to transport the post-processed sheet supplied to the sheet feed unit to the accumulation unit of the bookbinding device, and a bookbinding controller that performs control so as to execute bookbinding on the sheets transported to the accumulation unit of the bookbinding device after printing based on print data ends.

### CROSS-REFERENCE TO RELATED APPLICATIONS

This application is based on and claims priority under 35 USC 119 from Japanese Patent Application No. 2012-052347, filed Mar. 8, 2012.

### BACKGROUND

(i) Technical Field

The present invention relates to a bookbinding control device, a non-transitory computer readable medium, a bookbinding system, and a bookbinding control method.

(ii) Related Art

Bookbinding is performed on printed matter printed by a printer. In the bookbinding of the printed matter, when sheets of different sizes are included in the printed matter, bookbinding is performed after folding (for example, Z folding) is performed such that a sheet of large size fits with a sheet of small size.

For example, when a post-processing device which performs folding is connected at the back of a bookbinding device which performs bookbinding, a sheet subjected to folding is unable to be transported to the bookbinding device.

### SUMMARY

According to an aspect of the invention, there is provided a bookbinding control device includes an acquisition unit that acquires print data including post-processing unnecessary pages requiring no post-processing after printing and before bookbinding and post-processing necessary pages requiring post-processing, a printing controller that, after post-processed sheets on which post-processing is performed on sheets with the printed post-processing necessary pages are supplied to a sheet feed unit, prints the post-processing unnecessary pages in print data, a first transport controller that performs control so as to transport sheets with the printed post-processing unnecessary pages to an accumulation unit of a bookbinding device with respect to the post-processing unnecessary pages in print data, a second transport controller that performs control so as to transport the post-processed sheet supplied to the sheet feed unit to the accumulation unit of the bookbinding device with respect to the post-processing necessary pages in print data, and a bookbinding controller that performs control so as to execute bookbinding on the sheets transported to the accumulation unit of the bookbinding device after printing based on print data ends.

### BRIEF DESCRIPTION OF THE DRAWINGS

Exemplary embodiments of the present invention will be described in detail based on the following figures, wherein:

FIG. 1 is an overall configuration diagram of a bookbinding system according to this exemplary embodiment;

FIG. 2 is a diagram illustrating Z folding;

FIG. 3 is a diagram illustrating case bookbinding;

FIG. 4 is a schematic configuration diagram of a bookbinding device;

FIG. 5 is a diagram showing an example of the hardware configuration of a client device;

FIG. 6 is a diagram showing an example of the hardware configuration of a printer;

FIG. 7 is a diagram showing an example of the hardware configuration of a sheet feeding device;

FIG. 8 is a diagram showing an example of the hardware of a bookbinding device;

FIG. 9 is a diagram showing an example of the hardware configuration of a post-processing device;

FIG. 10 is a diagram showing an example of a print job table.

FIG. 11 is a flowchart illustrating the flow of bookbinding according to a first example;

FIG. 12 is a flowchart illustrating the flow of bookbinding according to the first example;

FIG. 13 is a flowchart illustrating the flow of bookbinding according to a second example;

FIG. 14 is a flowchart illustrating the flow of bookbinding according to the second example;

FIG. 15 is a flowchart illustrating the flow of bookbinding according to a third example; and

FIG. 16 is a flowchart illustrating the flow of bookbinding according to the third example.

### DETAILED DESCRIPTION

Hereinafter, a mode (hereinafter, referred to as an exemplary embodiment) for carrying out the invention will be described with reference to the drawings.

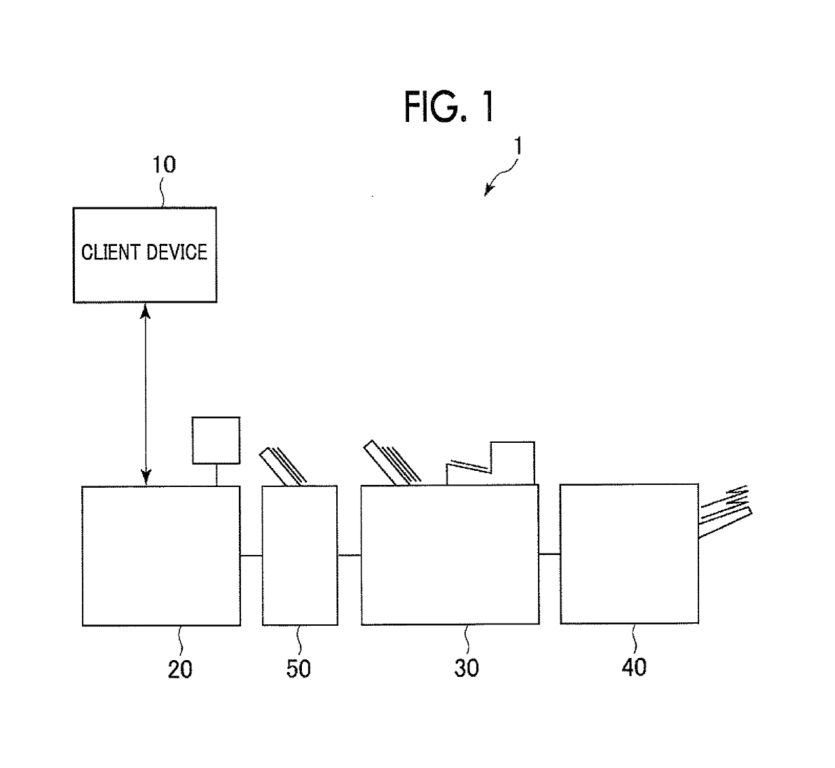

FIG. 1 is an overall configuration diagram of a bookbinding system 1 according to this exemplary embodiment. As shown in FIG. 1, the bookbinding system 1 includes a client device 10, a printer 20, a sheet feeding device 50, a bookbinding device 30, and a post-processing device 40. In this exemplary embodiment, the sheet transport paths of the printer 20, the sheet feeding device 50, the bookbinding device 30, and the post-processing device 40 are connected together in this order, and a sheet on which an image is formed (printed) by the printer 20 is transported from the sheet feeding device 50 to the bookbinding device 30 or to the post-processing device 40 through the internal transport path of the bookbinding device 30. Sheets which are used in bookbinding include sheets which are transported from the sheet feeding device 50 to the bookbinding device 30 and sheets which are transported to the bookbinding device 30 through the sheet feeding device 50 after having been printed by the printer 20.

The client device 10 is a computer which requests the printer 20 for printing. Although in this exemplary embodiment, print data with bookbinding designated is transmitted from the client device 10 toward the printer 20, data with bookbinding designated and data with no bookbinding designated may be mixed in print data.

The printer 20 controls printing and bookbinding on the basis of print data received from the client device 10. The details of printing and bookbinding will be described below.

The sheet feeding device 50 includes a tray (post-processed sheet insertion tray 506) which accumulates sheets subjected to post-processing by the post-processing device 40, and transports the sheets accumulated in the tray to the bookbinding device 30 on the basis of an instruction of the printer 20. The details of sheet transport processing of the sheet feeding device 50 will be described below.

The post-processing device 40 acquires sheets printed by the printer 20 through the internal transport path of the bookbinding device 30 and performs designated post-processing on the acquired sheets.

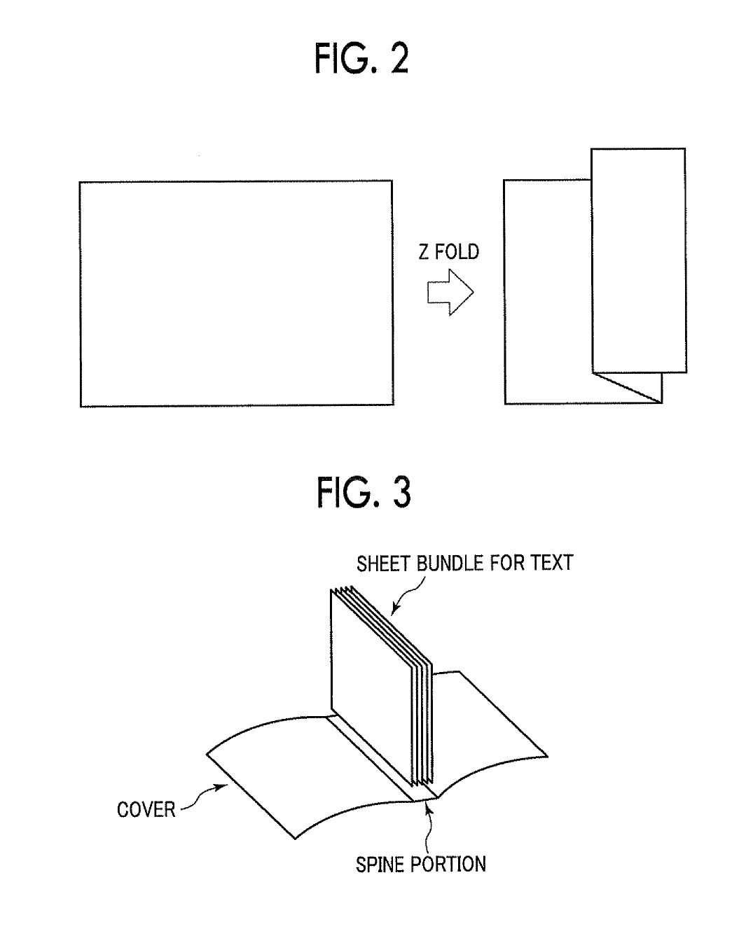

In this exemplary embodiment, the processing which is performed by the post-processing device 40 is folding shown in FIG. 2 which is called Z folding. Z folding refers to a folding method in which forward folding (or backward folding) of the long side of the sheet is performed, and then backward folding (or forward folding) of the forward-folded (or backward-folded) portion is performed. For example, when Z folding is performed such that the length of the long side of an A3 sheet is equal to or smaller than the length of the short side of an A4 sheet, the A3 sheet after Z folding does not protrude when overlapping the A4 sheet.

The bookbinding device 30 binds sheets printed by the printer 20 and sheets subjected to post-processing by the post-processing device 40. Hereinafter, a specific example of bookbinding in this exemplary embodiment will be described.

In this exemplary embodiment, the bookbinding device 30 performs bookbinding shown in FIG. 3 which is a so-called case bookbinding. Case bookbinding is a bookbinding method in which a sheet bundle for text including Z-folded pages and normal pages not subjected to Z folding arranged in a prescribed order is bonded to a cover page, a so-called case cover, with a spine portion at the center thereof. When bonding the cover page and the sheet bundle for text, an adhesive, such as paste, may be used.

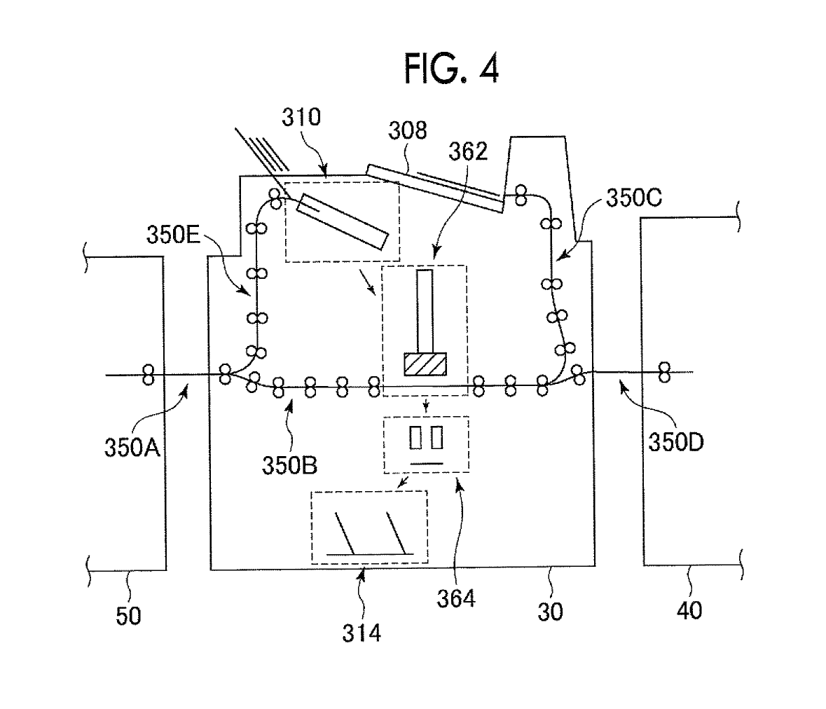

The flow of bookbinding by the bookbinding device 30 will be described with reference to a schematic configuration diagram of the bookbinding device 30 shown in FIG. 4.

As shown in FIG. 4, the sheets printed by the printer 20 are transported toward the bookbinding device 30 through a transport path 350A from the sheet feeding device 50. Of the printed sheets, the cover page is output to a tray 308 for a cover through the transport path 350A, a transport path 350B, and a transport path 3500. Of the printed sheets, pages (post-processing necessary pages) on which post-processing by the post-processing device 40 is necessary and sheets on which post-processing are not yet performed are output to the post-processing device 40 through the transport path 350A, the transport path 350B, and a transport path 350D. Of the printed sheets, pages (post-processing necessary pages) on which post-processing is unnecessary and sheets subjected to post-processing are output to an accumulation tray 310 through the transport path 350A and a transport path 350E.

Next, the bookbinding device 30 transports a sheet bundle for text, in which the post-processing necessary pages and the post-processing unnecessary pages are arranged in a prescribed order and which is disposed in the accumulation tray 310, to a pasting unit 362, and transports the cover page from the tray 308 for a cover to the pasting unit 362. After the sheet bundle for text and the cover page are bonded in the pasting unit 362, cutting is performed using a cutting unit 364, and output to a bookbinding output tray 314 is performed.

Next, a hardware configuration example of each of the client device 10, the printer 20, the sheet feeding device 50, the bookbinding device 30, and the post-processing device 40 will be described in order.

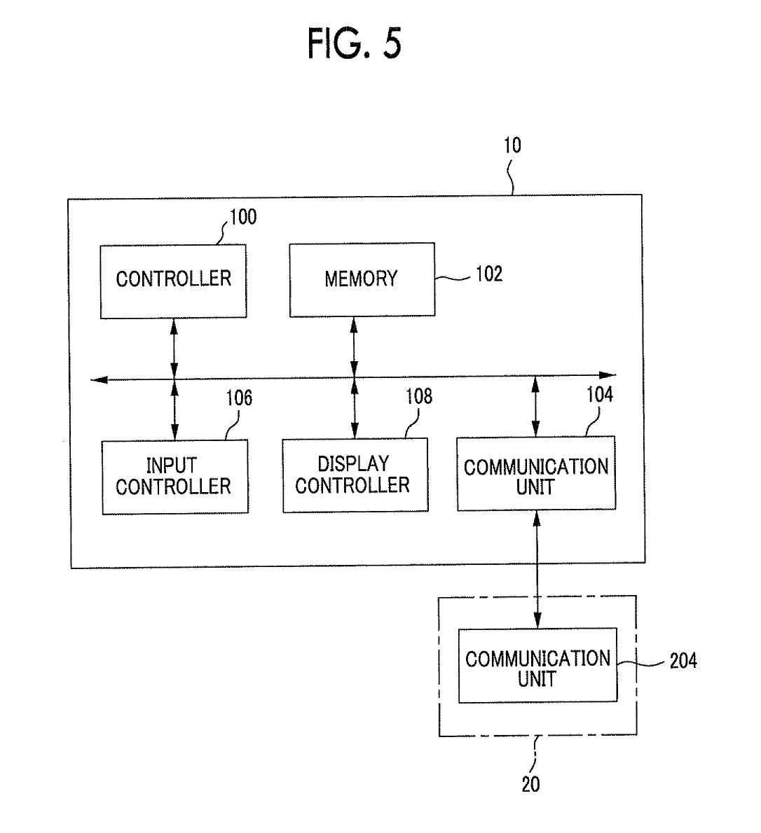

FIG. 5 shows an example of the hardware configuration of the client device 10. As shown in FIG. 5, the client device 10 includes a controller 100, a memory 102, a communication unit 104, an input controller 106, and a display controller 108.

The controller 100 includes a Central Processing Unit (CPU). The controller 100 performs various kinds of arithmetic processing on the basis of a program stored in the memory 102 and controls the respective units of the client device 10.

The memory 102 stores a control program, such as an operating system of the client device 10, or data, and is used as a work memory of the controller 100. A program may be supplied in a state of being stored in an information storage medium, such as an optical disc, a magnetic disk, a magnetic tape, a magnetic-optical disc, or a flash memory, to the client device 10 or may be supplied to the client device 10 through data communication means, such as Internet.

The communication unit 104 performs data communication with other devices (for example, the printer 20 and the like) using a communication interface, such as a network card or a serial communication card. In this exemplary embodiment, the communication unit 104 of the client device 10 performs data communication with a communication unit 204 of the printer 20.

The input controller 106 is connected to an input device, such as a mouse or a keyboard, and receives an operation input from a user.

The display controller 108 is embedded in the client device 10 or is connected to an external display device, such as a liquid crystal display, and performs control such that the display device displays the result (screen) of information processing in the client device 10.

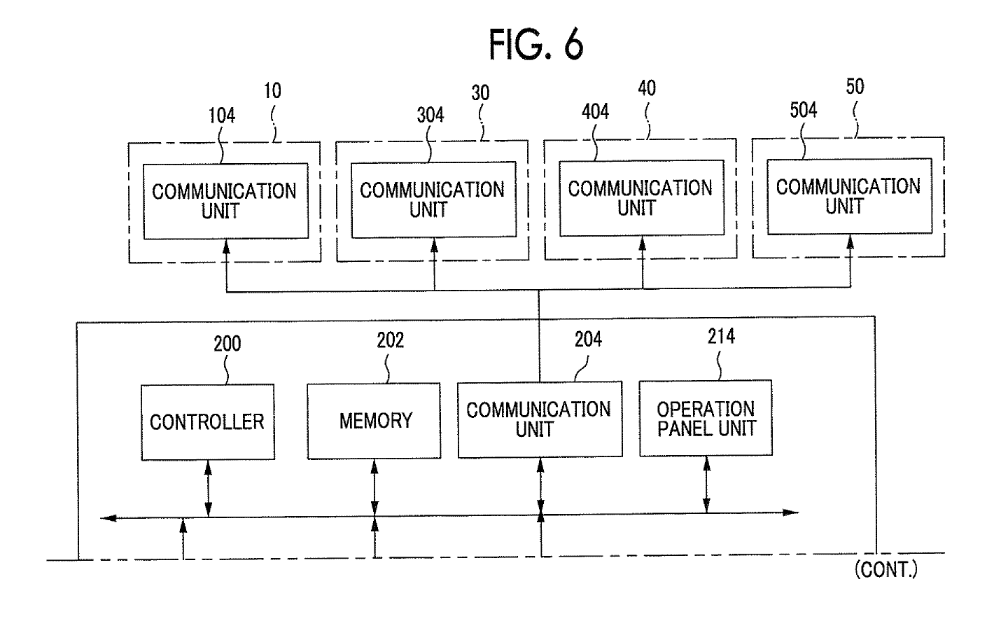

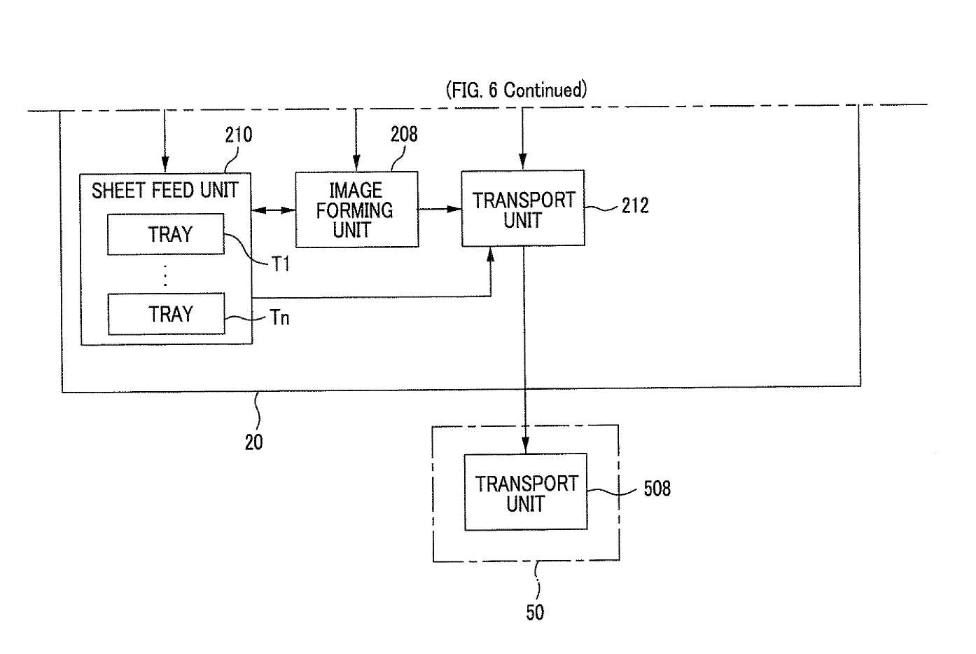

Next, the configuration of the printer 20 will be described. FIG. 6 shows an example of the hardware configuration of the printer 20. As shown in FIG. 6, the printer 20 includes a controller 200, a memory 202, a communication unit 204, an image forming unit 208, a sheet feed unit 210, a transport unit 212, and an operation panel unit 214.

The controller 200 includes a CPU (Central Processing Unit). The controller 200 performs various kinds of arithmetic processing on the basis of a program stored in the memory 202 and controls the respective units of the printer 20.

The memory 202 stores a control program of the printer 20 or data, and is used as a work memory of the controller 200. A program may be supplied to the printer 20 in a state of being stored in an information storage medium, such as an optical disc, a magnetic disk, a magnetic tape, a magnetic-optical disc, or a flash memory, or may be supplied to the printer 20 through data communication means, such as Internet.

The communication unit 204 performs data communication with other devices (for example, the client device 10, the bookbinding device 30, the post-processing device 40, the sheet feeding device 50, and the like) using a communication interface, such as a network card or a serial communication card. In this exemplary embodiment, the communication unit 204 of the printer 20 performs data communication with the communication unit 104 of the client device 10, a communication unit 304 of the bookbinding device 30, a communication unit 404 of the post-processing device 40, and a communication unit 504 of the sheet feeding device 50.

The image forming unit 208 forms an image on a printing medium (printing sheet) fed from the sheet feed unit 210 in accordance with an image forming command (print job) input from the controller 200. For example, the image forming unit 208 may form an image using a laser printer system or may form an image using an ink jet printer system.

The sheet feed unit 210 includes one or multiple trays T1 to Tn (where n is a natural number). The sheet feed unit 210 extracts a printing medium from a tray which stores a designated printing medium (printing sheet), and feeds the printing medium to the image forming unit 208 or the transport unit. For example, the trays T1 to Tn may include a tray for each sheet size (for example, A3, A4, or the like), a tray for colored sheets, and the like. The sheet feed unit 210 may be embedded in the printer 20 or may be provided outside the printer 20.

The transport unit 212 transports a printing sheet on which an image is formed using the image forming unit 208. For example, the transport unit 212 transports a printing medium on which an image is formed by the image forming unit 208 or transports a printing medium fed from the sheet feed unit 210. In this exemplary embodiment, the transport unit 212 of the printer 20 is connected to a transport unit 508 of the sheet feeding device 50 and sends a printing medium to the transport unit 508.

The operation panel unit 214 is a display function-equipped input device which includes a display device, such as a liquid crystal display, and a button-type or touch panel-type input device. The operation panel unit 214 functions as an interactive interface with a user who operates the printer 20.

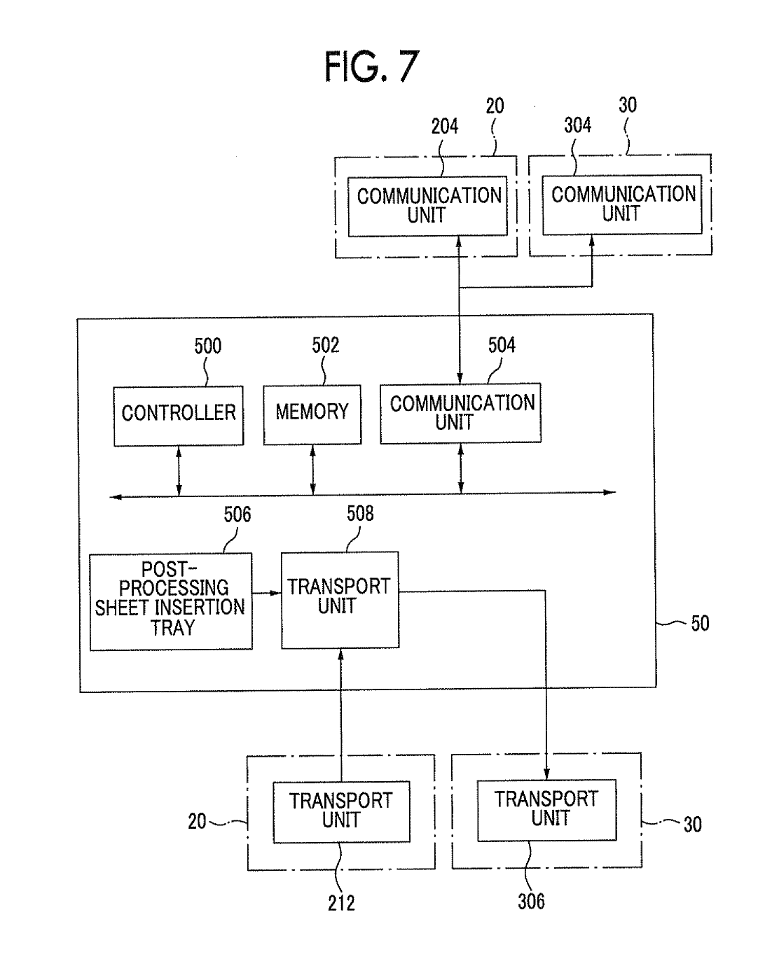

Next, the configuration of the sheet feeding device 50 will be described. FIG. 7 shows an example of the hardware configuration of the sheet feeding device 50. As shown in FIG. 7, the sheet feeding device 50 includes a controller 500, a memory 502, a communication unit 504, a post-processed sheet insertion tray 506, and a transport unit 508.

The controller 500 includes a CPU (Central Processing Unit). The controller 500 performs various kinds of arithmetic processing on the basis of a program stored in the memory 502 and controls the respective units of the sheet feeding device 50.

The memory 502 stores a control program of the sheet feeding device 50 or data, and is used as a work memory of the controller 500. A program may be supplied in a state of being stored in an information storage medium, such as an optical disc, a magnetic disk, a magnetic tape, a magnetic-optical disc, or a flash memory, to the sheet feeding device 50 or may be supplied to the sheet feeding device 50 through data communication means, such as Internet.

The communication unit 504 performs data communication with other devices (for example, the printer 20, the bookbinding device 30, and the like) using a communication interface, such as a network card or a serial communication card. In this exemplary embodiment, the communication unit 504 of the sheet feeding device 50 performs data communication with the communication unit 204 of the printer 20 or the communication unit 304 of the bookbinding device 30.

The transport unit 508 transports printed sheets transported from the printer 20 or sheets accumulated in the post-processed sheet insertion tray 506 to the bookbinding device 30. For example, the transport unit 508 transports the printed sheets transported from the printer 20 directly to the bookbinding device 30, when an instruction to transport sheets accumulated in the post-processed sheet insertion tray 506 is received from the printer 20, loads one sheet accumulated in the post-processed sheet insertion tray 506, and transports the loaded sheet to the bookbinding device 30.

The post-processed sheet insertion tray 506 is a tray which accumulates sheets (post-processed sheets) subjected to post-processing by the post-processing device.

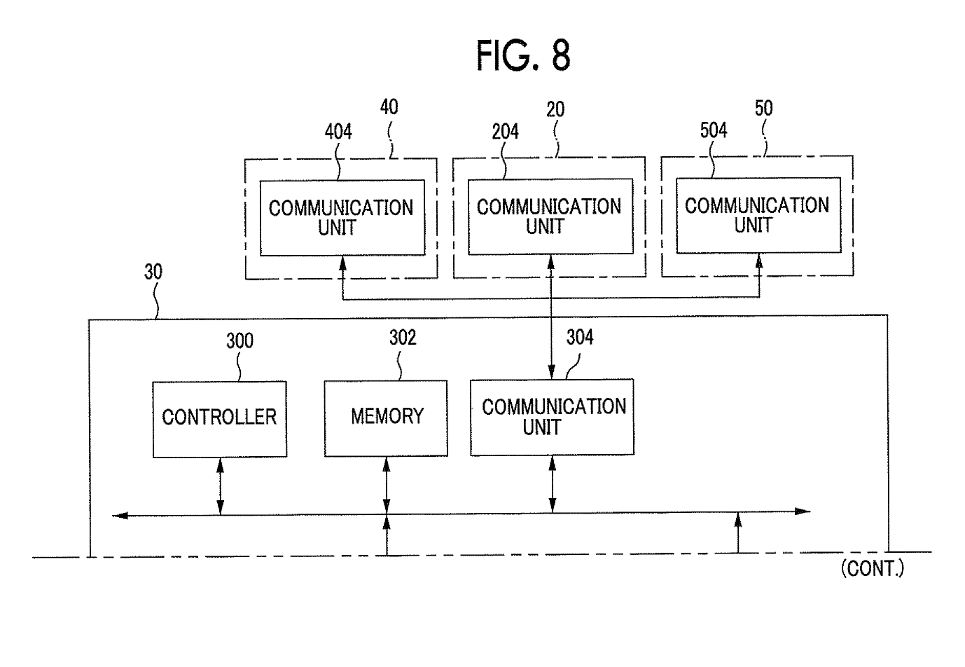

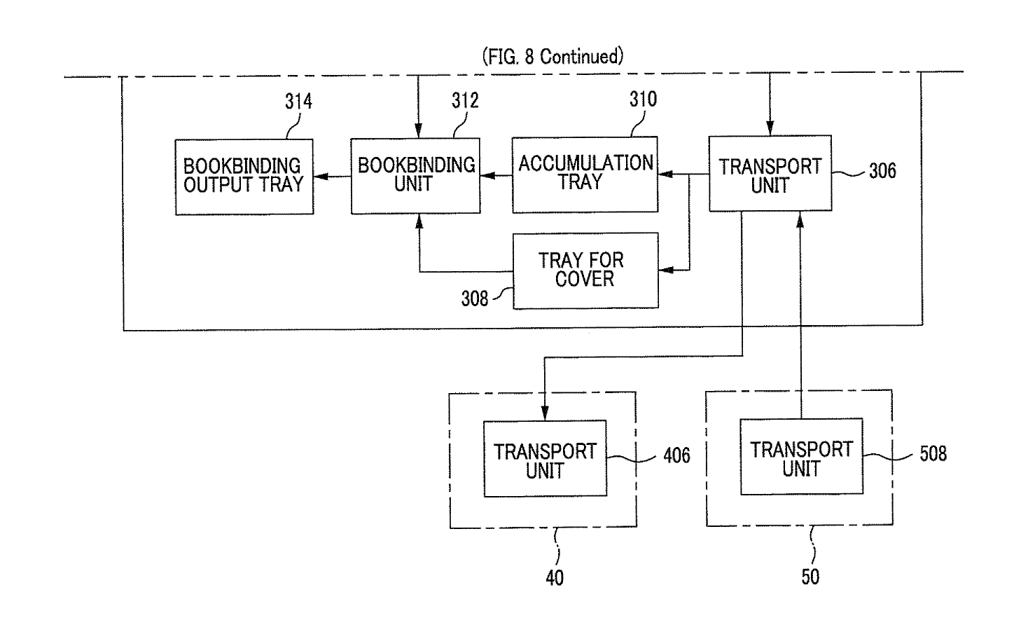

Next, the configuration of the bookbinding device 30 will be described. FIG. 8 shows an example of the hardware configuration of the bookbinding device 30. As shown in FIG. 8, the bookbinding device 30 includes a controller 300, a memory 302, a communication unit 304, a transport unit 306, a tray 308 for a cover, an accumulation tray 310, a bookbinding unit 312, and a bookbinding output tray 314.

The controller 300 includes a CPU (Central Processing Unit). The controller 300 performs various kinds of arithmetic processing on the basis of a program stored in the memory 302 and controls the respective units of the bookbinding device 30.

The memory 302 stores a control program of the bookbinding device 30 or data, and is used as a work memory of the controller 300. A program may be supplied to the bookbinding device 30 in a state of being stored in an information storage medium, such as an optical disk, a magnetic disc, a magnetic tape, a magnetic-optical disc, or a flash memory, or may be supplied to the bookbinding device 30 through data communication means, such as Internet.

The communication unit 304 performs data communication with other devices (for example, the printer 20, the post-processing device 40, the sheet feeding device 50, and the like) using a communication interface, such as a network card or a serial communication card. In this exemplary embodiment, the communication unit 304 of the bookbinding device 30 performs data communication with the communication unit 204 of the printer 20, a communication unit 404 of the post-processing device 40, or a communication unit 504 of the sheet feeding device 50.

The transport unit 306 transports a printed sheet transported from the sheet feeding device 50 to the tray 308 for a cover or the accumulation tray 310 of the bookbinding device 30, or transports the printed sheet to the post-processing device 40. For example, when a printed sheet transported from the sheet feeding device 50 is a cover page, the transport unit 306 transports the printed sheet to the tray 308 for a cover, and when a printed sheet which is transported from the sheet feeding device 50 is a post-processing unnecessary page or a post-processing necessary page and post-processing is completed, the transport unit 306 transport the printed sheet to the accumulation tray 310. When a printed sheet which is transported from the printer 20 is a post-processing necessary page and post-processing is not yet completed, the transport unit 306 sends the printed sheet to the post-processing device 40.

The tray 308 for a cover is a tray which accumulates a medium (paper) as a cover for bookbinding.

The accumulation tray 310 is a tray which accumulates media (papers) as text for bookbinding.

The bookbinding unit 312 performs bookbinding with a medium accumulated in the tray 308 for a cover as a cover page and media accumulated in the accumulation tray 310 as text (a sheet bundle for text). A specific flow of bookbinding is as described above, and thus description thereof will not be repeated.

The bookbinding output tray 314 is a tray in which a product (book) from the bookbinding unit 312 is loaded.

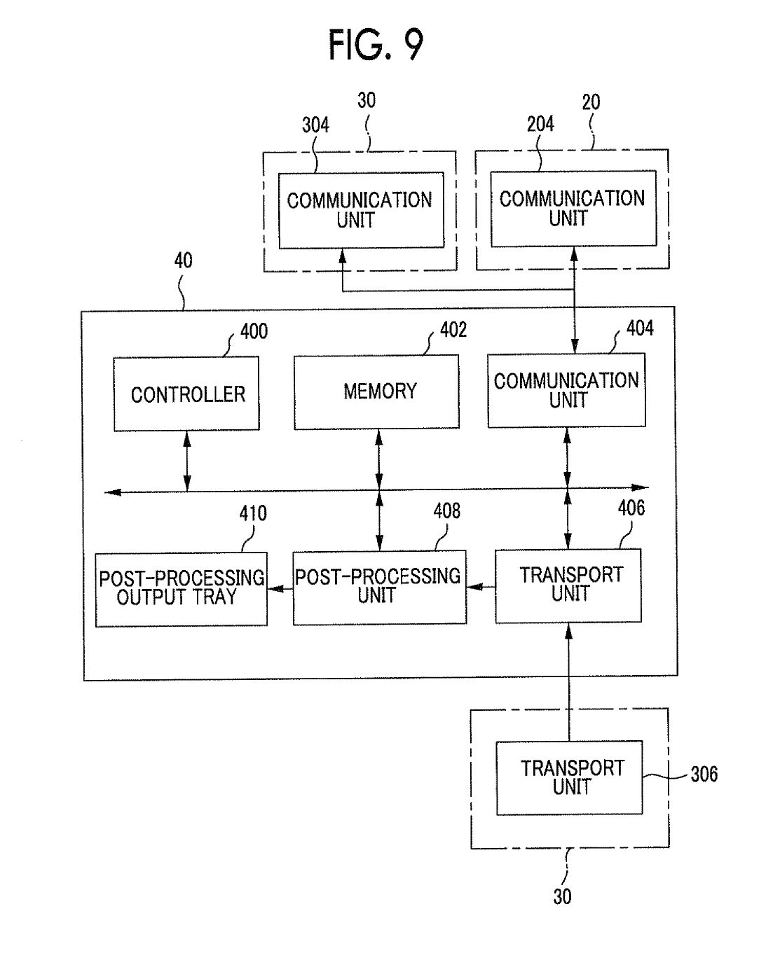

Next, the configuration of the post-processing device 40 will be described. FIG. 9 shows an example of the hardware configuration of the post-processing device 40. As shown in FIG. 9, the post-processing device 40 includes a controller 400, a memory 402, a communication unit 404, a transport unit 406, a post-processing unit 408, and a post-processing output tray 410.

The controller 400 includes a CPU (Central Processing Unit). The controller 400 performs various kinds of arithmetic processing on the basis of a program stored in the memory 402 and controls the respective units of the post-processing device 40.

The memory 402 stores a control program of the post-processing device 40 or data, and is used as a work memory of the controller 400. A program may be supplied to the post-processing device 40 in a state of being stored in an information storage medium, such as an optical disc, a magnetic disk, a magnetic tape, a magnetic-optical disc, or a flash memory, or may be supplied to the post-processing device 40 through data communication means, such as Internet.

The communication unit 404 performs data communication with other devices (for example, the printer 20, the bookbinding device 30, and the like) using a communication interface, such as a network card or a serial communication card. In this exemplary embodiment, the communication unit 404 of the post-processing device 40 performs data communication with the communication unit 204 of the printer 20 or the communication unit 304 of the bookbinding device 30.

The transport unit 406 is connected to the transport unit 306 of the bookbinding device 30, and transports a printing sheet transported from the transport unit 306 of the bookbinding device 30 to the post-processing unit 408.

The post-processing unit 408 performs designated post-processing on a printing medium transported from the transport unit 406. In this exemplary embodiment, the post-processing unit 408 performs Z folding on the transported printing medium and discharges the printing medium after Z folding to the post-processing output tray 410.

The post-processing output tray 410 is a tray which accumulates printing mediums subjected to post-processing by the post-processing unit 408 (that is, sheets subjected to Z folding).

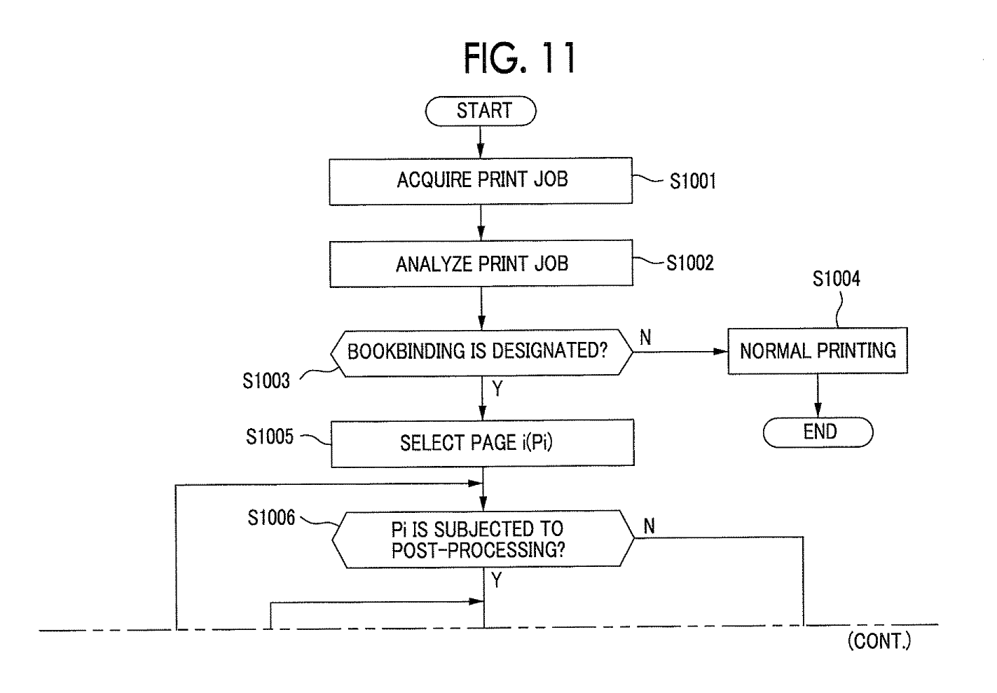

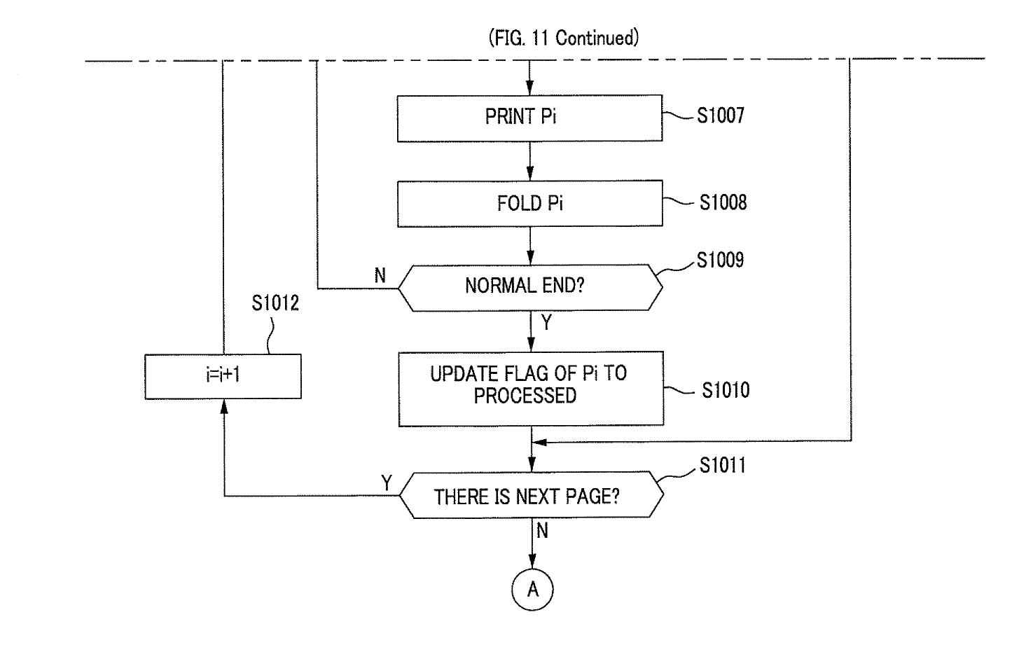

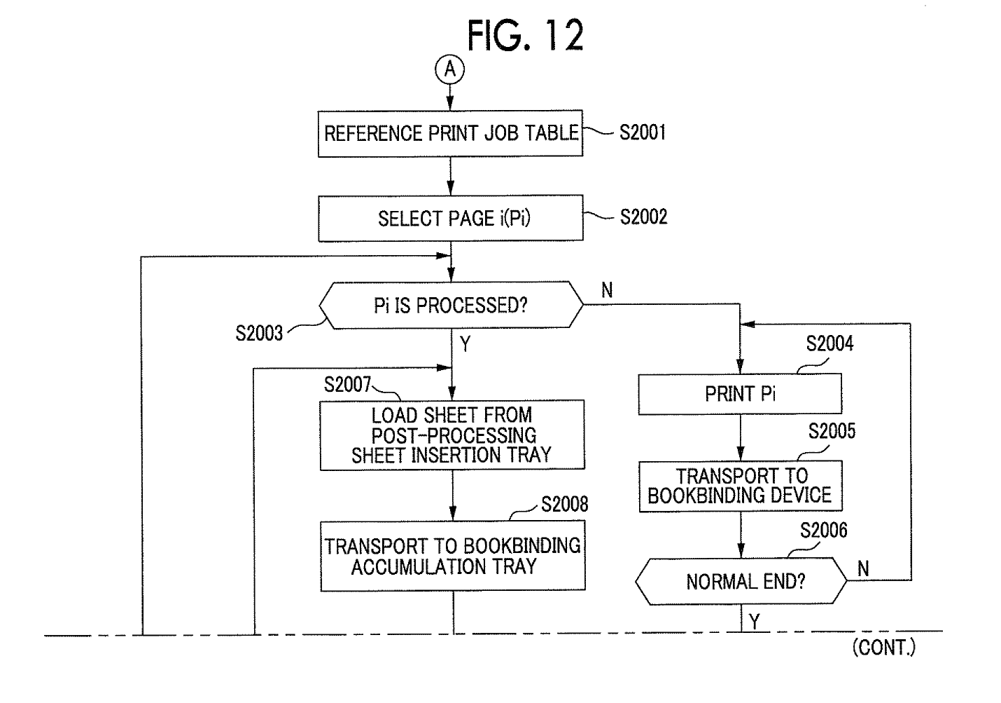

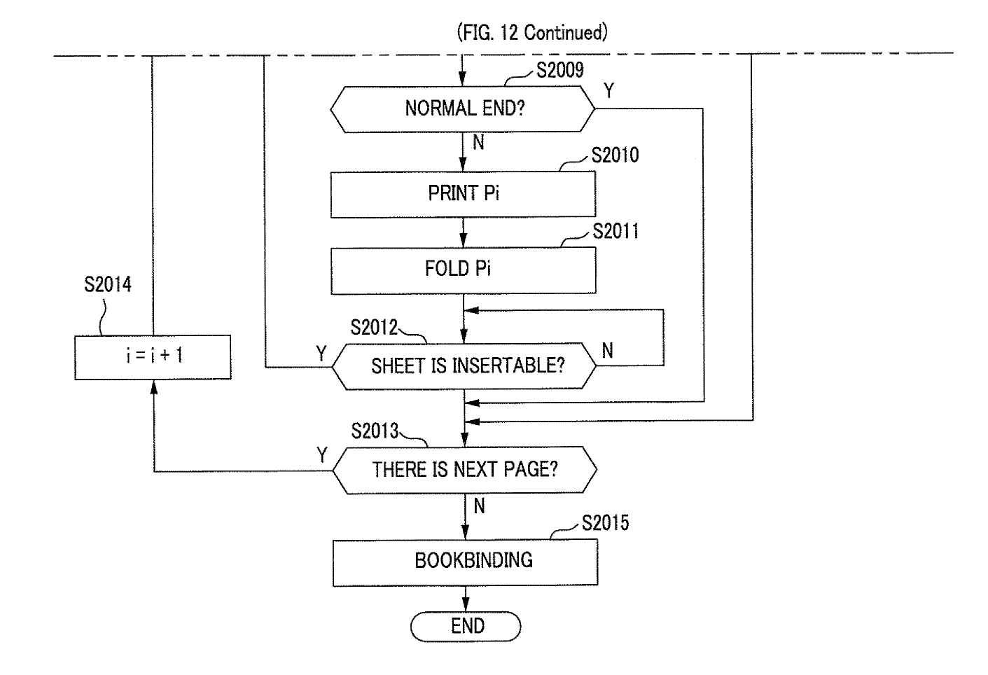

Next, the flow of bookbinding according to a first example in the bookbinding system 1 will be described with reference to flowcharts of FIGS. 11 and 12. The first example illustrates an example where processing for bookbinding one volume, specifically, printing of post-processing necessary pages, post-processing printing of post-processing unnecessary pages, and bookbinding are performed on the basis of a single print job.

As shown in FIG. 11, the printer 20 acquires a print job from the client device 10 (S1001), and analyzes the acquired print job (S1002). For example, the printer 20 may acquire information, such as the presence/absence of bookbinding designation of the print job, the attributes (cover, presence/absence of Z folding designation, printing size, and the like) of each page printed on the basis of the print job, and RIP data of each page. The printer 20 may create a print job table described below representing the processing state of the print job on the basis of the analysis result in S1002 and may store the print job table in the memory 202 of the printer 20.

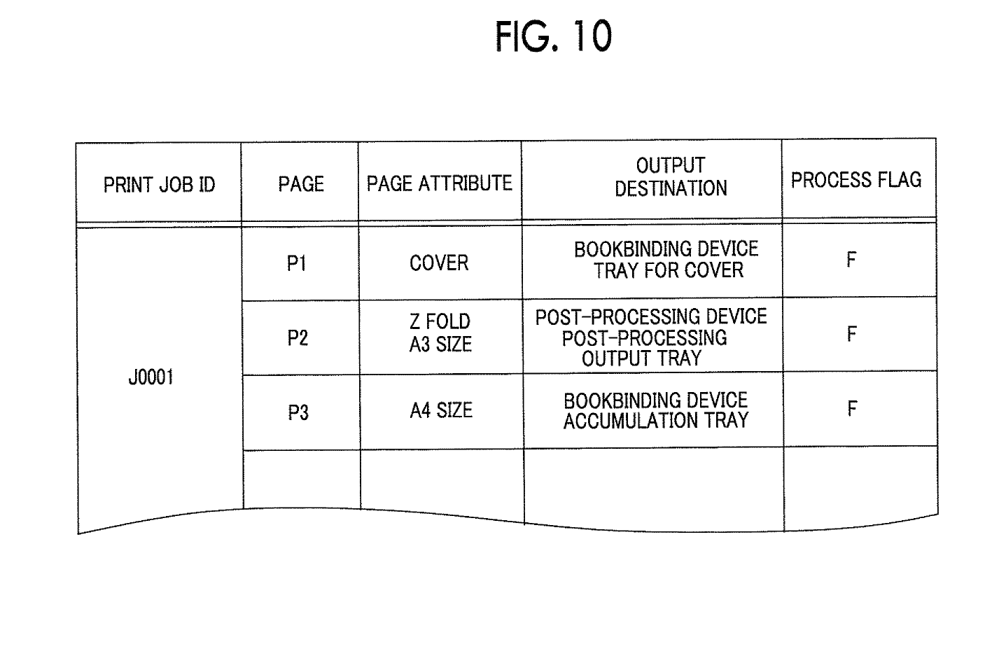

FIG. 10 shows an example of a print job table. As shown in FIG. 10, the print job table stores a print job ID for identifying a print job, page attributes for each page to be printed by the print job, an output destination, and a processing completion flag in association with each other. For example, the output destination is information representing a device and a tray in which pages are discharged, and the processing completion flag is information representing whether or not to output a page. The processing completion flag is unprocessed (F) by default, and is changed to processed (T) when the processing is performed.

When no bookbinding is designated in the print job (S1003: N), the printer 20 performs normal printing (S1004) and ends the process. When bookbinding is designated in the print job (S1003: Y), the printer 20 performs the following process.

The printer 20 selects a page Pi (where i is an integer of 1 to K, and the initial value of i is 1) which is printed on the basis of the print job (S1005), and when Pi is to be post-processed (S1006: Y), Pi is printed (S1007), and the printed Pi is transported to the post-processing device 40. The determination on whether or not Pi is to be post-processed may be made by determining whether or not the size of Pi is larger than preset size (if larger, Pi is to be post-processed).

After the transported Pi is folded (S1008), the post-processing device 40 discharges the folded Pi to the post-processing output tray 410. When the processing result in S1008 is not a normal end (S1009: N), the post-processing device 40 returns to S1007. When the processing result in S1008 is a normal end (S1009: Y), for example, the post-processing device 40 updates a processing completion flag of Pi in the print job table shown in FIG. 10 to processed (T) (S1010).

When Pi is not to be post-processed (S1006: N), or after S1010, the printer 20 determines whether or not there is a next page to Pi (that is, whether or not i=K) (S1011), when there is a next page (S1011: Y), increments i (S1012), returns to S1006, and repeats the process after S1006. In S1011, when there is no next page (S1011: N), an instruction to move a folded sheet bundle discharged into the post-processing output tray 410 of the post-processing device 40 to the post-processed sheet insertion tray 506 of the sheet feeding device 50 is given to the user, and the processing of the print job is paused. After the folded sheet bundle is disposed in the post-processed sheet insertion tray 506 by the user, if an input to restart the process is received from the user, the printer 20 restarts the processing of the print job and progresses to the flow of FIG. 12. As will be apparent from the flow shown in FIG. 11, printing and post-processing of all of the post-processing necessary pages are performed before printing of the post-processing unnecessary pages.

As shown in FIG. 12, the printer 20 references the print job table (S2001), and selects the page Pi (where i is an integer of 1 to K, and the initial value of i is 1) on the basis of the print job (S2002).

When Pi in the print job table is not printed (S2003: N), the printer 20 prints Pi (S2004), and transports the printed to the bookbinding device 30 (S2005). For example, if Pi is a cover, Pi may be transported to the tray 308 for a cover of the bookbinding device 30, and if Pi is a folding unnecessary page, Pi may be transported to the accumulation tray 310 of the bookbinding device 30. When the processing result in S2004 and S2005 is not a normal end (S2006: N), the printer 20 returns to S2004, and performs the processing until the processing result becomes a normal end (S2006: Y).

Next, when Pi in the print job table is printed (S2003: Y), the printer 20 loads the sheets accumulated in the post-processed sheet insertion tray 506 of the sheet feeding device 50 one by one (S2007), and transports the loaded sheet to the accumulation tray 310 of the bookbinding device 30 (S2008). When the processing result in S2007 and S2008 is not a normal end (S2009: N), the printer 20 prints Pi (S2010), and transports the printed Pi to the post-processing device 40. The post-processing device 40 folds the transported Pi (S2011), and then discharges the folded Pi to the post-processing output tray 410. When Pi is not insertable from the post-processed sheet insertion tray 506 of the sheet feeding device 50 (S2012: N), the printer 20 stands by. When Pi is insertable (S2012: Y), the printer 20 returns to S2007. In S2012, the determination on whether or not Pi is insertable from the post-processed sheet insertion tray 506 may be made on the basis of an input from the user when the user receives an inquiry through the operation panel unit 214 of the printer 20, or may be made on the basis of the detection result of a sensor which is provided to detect the placement of a sheet in the post-processed sheet insertion tray 506.

When the processing result in S2004 and S2005 is a normal end (S2006: Y), or when the processing result in S2007 and S2008 is a normal end (S2009: Y), printer 20 determines whether or not there is a next page of Pi (that is, whether or not 1=K) (S2013), when there is a next page (S2013: Y), increments i (S2014), returns to S2003, and repeats the process after S2003. In S2013, when there is no next page (S2013: N), bookbinding is performed on the sheets accumulated in the bookbinding device 30 (S2015), and the process ends.

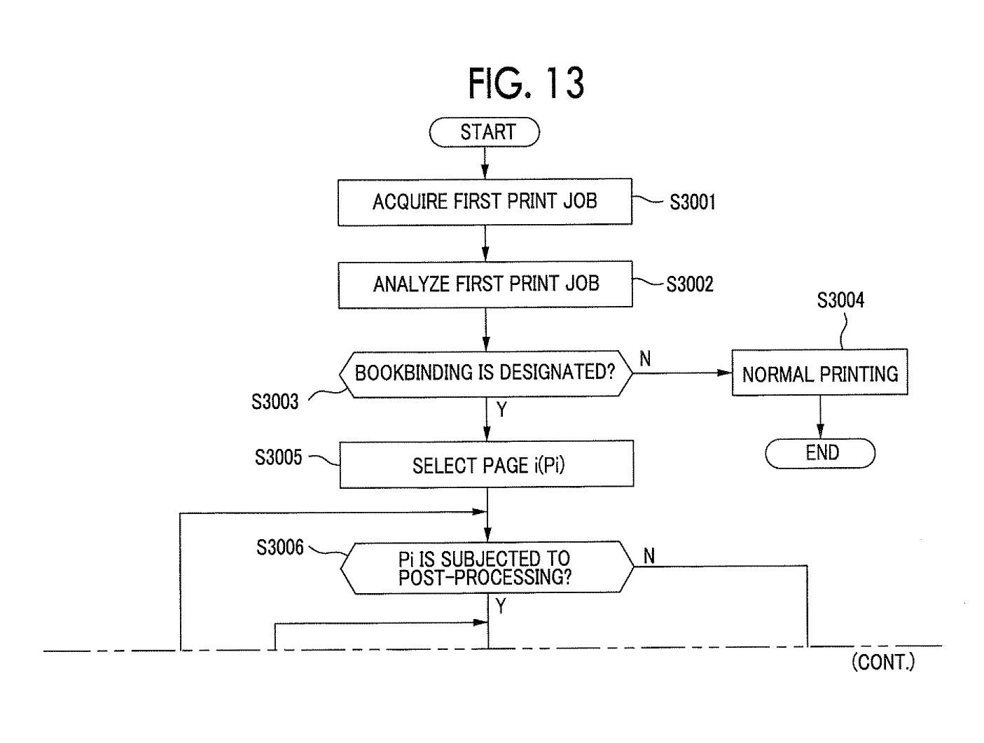

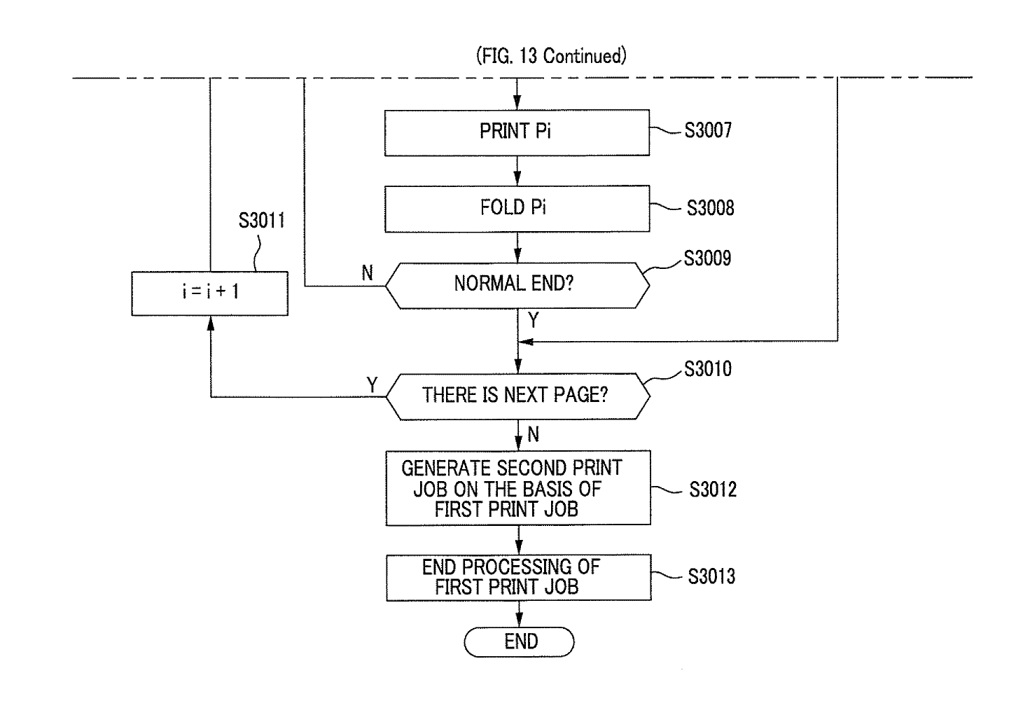

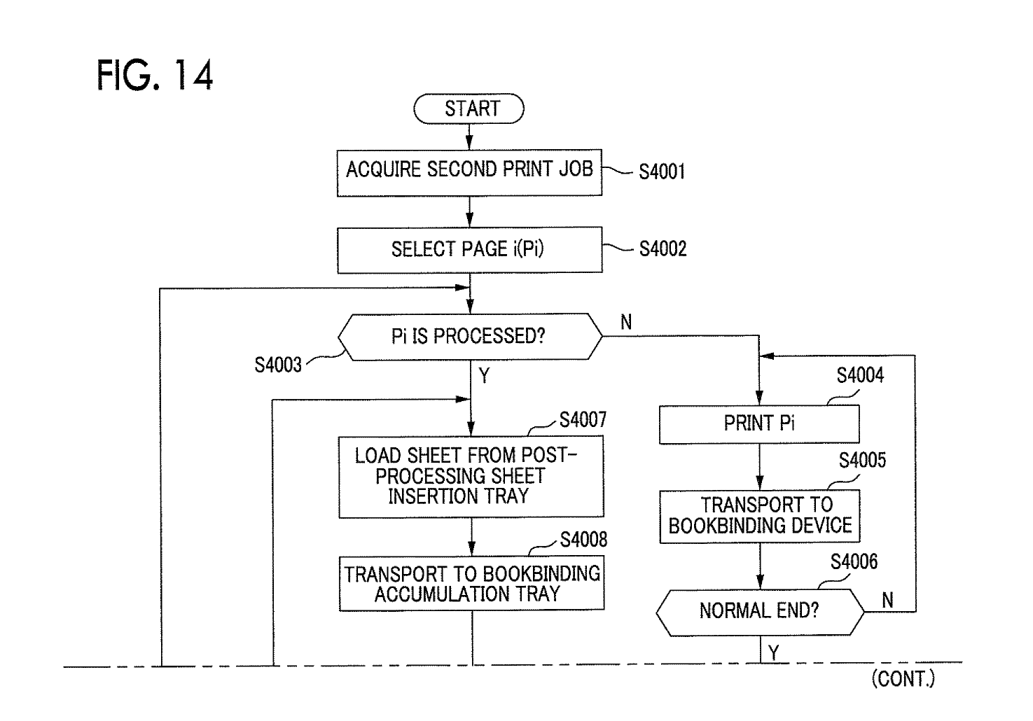

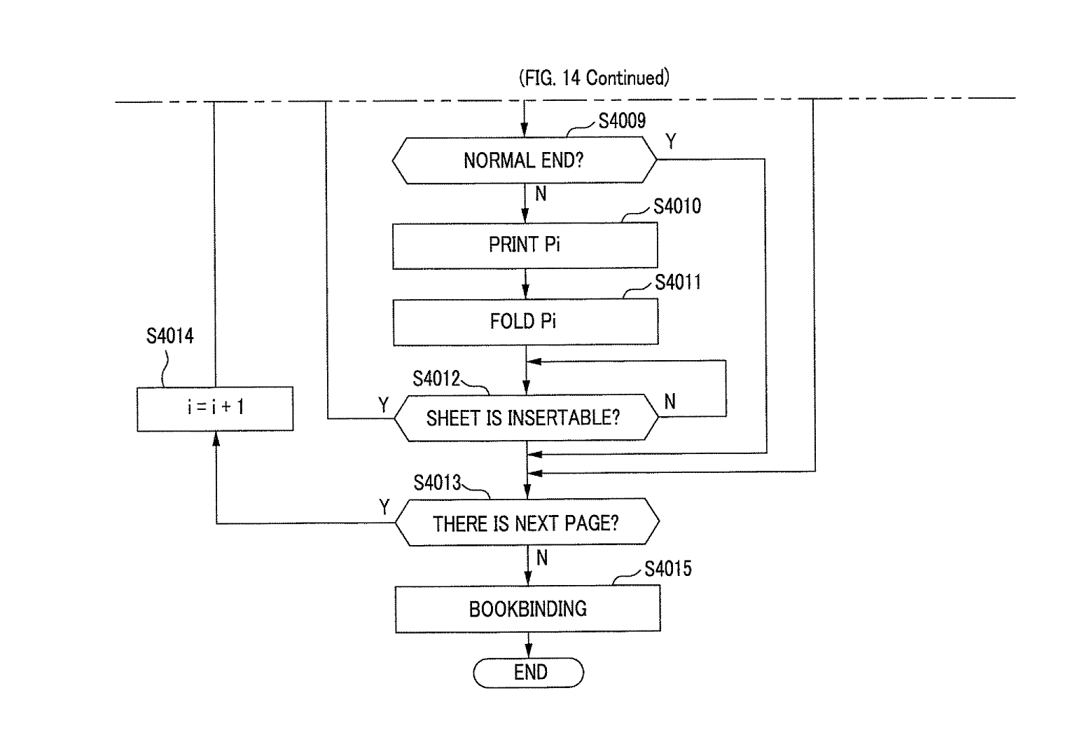

Next, the flow of bookbinding according to a second example in the bookbinding system 1 will be described with reference to flowcharts shown in FIGS. 13 and 14. The second example illustrates an example where processing for bookbinding one volume, specifically, printing of post-processing necessary pages and post-processing are treated as one print job, and printing of post-processing unnecessary pages and bookbinding are treated as another print job.

As shown in FIG. 13, the printer 20 acquires a first print job from the client device 10 (S3001), and analyzes the acquired first print job (S3002). For example, the printer 20 may acquire information, such as the presence/absence of bookbinding designation of the print job, the attributes (cover, presence/absence of Z folding designation, printing size, and the like) of each page printed on the basis of the print job, and RIP data of each page.

When no bookbinding is designated in the first print job (S3003: N), the printer 20 performs normal printing (S3004) and ends the process. When bookbinding is designated in the first print job (S3003: Y), the printer 20 performs the following process.

The printer 20 selects a page Pi (where i is an integer of 1 to K, and the initial value of i is 1) which is printed on the basis of the first print job (S3005). When Pi is to be post-processed (S3006: Y), the printer 20 prints Pi (S3007), and transports the printed Pi to the post-processing device 40.

The post-processing device 40 folds the transported Pi (S3008), and then discharges the folded Pi to the post-processing output tray 410. When the processing result in S3008 is not a normal end (S3009: N), the post-processing device 40 returns to S3007.

When Pi is not to be post-processed (S3006: N), or when the processing result in S3008 is a normal end (S3009: Y), the printer 20 determines whether or not there is a next page to Pi (that is, whether or not i=K) (S3010), when there is a next page (S3010: Y), increments i (S3012), returns to S3006, and repeats the process after S3006. In S3010, when there is no next page (S3011: N), a second print job is generated on the basis of the first print job (S3012). The second print job may be data in which the first print job is given an attribute indicating that the processing of the post-processing necessary pages ends. If the second print job is generated, the printer 20 ends the processing of the first print job (S3013). As will be apparent from the flow shown in FIG. 13, printing of all post-processing necessary pages and post-processing are performed before printing of the post-processing unnecessary pages. Hereinafter, processing after a folded sheet bundle discharged to the post-processing output tray 410 of the post-processing device 40 on the basis of the first print job is placed in the post-processed sheet insertion tray 506 by the user will be described.

Next, as shown in FIG. 14, if an instruction to process the second print job is received from the client device 10, the printer 20 acquires the second print job (S4001), and selects the page P (where i is an integer of 1 to K, and the initial value of i is 1) which is printed on the basis of the second print job (S4002).

When Pi is not printed (that is, post-processing necessary page) (S4003: N), the printer 20 prints Pi (S4004), and transports the printed Pi to the bookbinding device 30 (S4005). For example, if Pi is a cover, Pi may be transported to the tray 308 for a cover of the bookbinding device 30. If Pi is a folding unnecessary page, Pi may be transported to the accumulation tray 310 of the bookbinding device 30. When the processing result in S4004 and S4005 is not a normal end (S4006: N), the printer 20 returns to S4004, and performs the processing until the processing result becomes a normal end (S4006: Y).

Next, when Pi is printed (that is, post-processing necessary page) (S4003: Y), the printer 20 loads the sheets accumulated in the post-processed sheet insertion tray 506 of the sheet feeding device 50 one by one (S4007), and transports the loaded sheet to the accumulation tray 310 of the bookbinding device 30 (S4008). When the processing result in S4007 and S4008 is not a normal end (S4009: N), the printer 20 prints Pi (S4010), and transports the printed Pi to the post-processing device 40. The post-processing device 40 folds the transported Pi (S4011), and discharges the folded Pi to the post-processing output tray 410. When Pi is not insertable from the post-processed sheet insertion tray 506 of the sheet feeding device 50 (S4012: N), the printer 20 stands by. When Pi is insertable (S4012: Y), the printer 20 returns to S4007. In S4012, the determination on whether or not Pi is insertable from the post-processed sheet insertion tray 506 may be made on the basis of an input from the user when the user receives an inquiry through the operation panel unit 214 of the printer 20, or may be made on the basis of the detection result of a sensor which is provided to detect the placement of a sheet in the post-processed sheet insertion tray 506.

When the processing result in S4004 and S4005 is a normal end (S4006: Y), or when the processing result in S4007 and S4008 is a normal end (S4009: Y), the printer 20 determines whether or not there is a next page to Pi (that is, whether or not i=K) (S4013), when there is a next page (S4013: Y), increments i (S4014), returns to S4003, and repeats the process after S4003. In S4013, when there is no next page (S4013: N), bookbinding is performed on the sheets accumulated in the bookbinding device 30 (S4015), and the process ends.

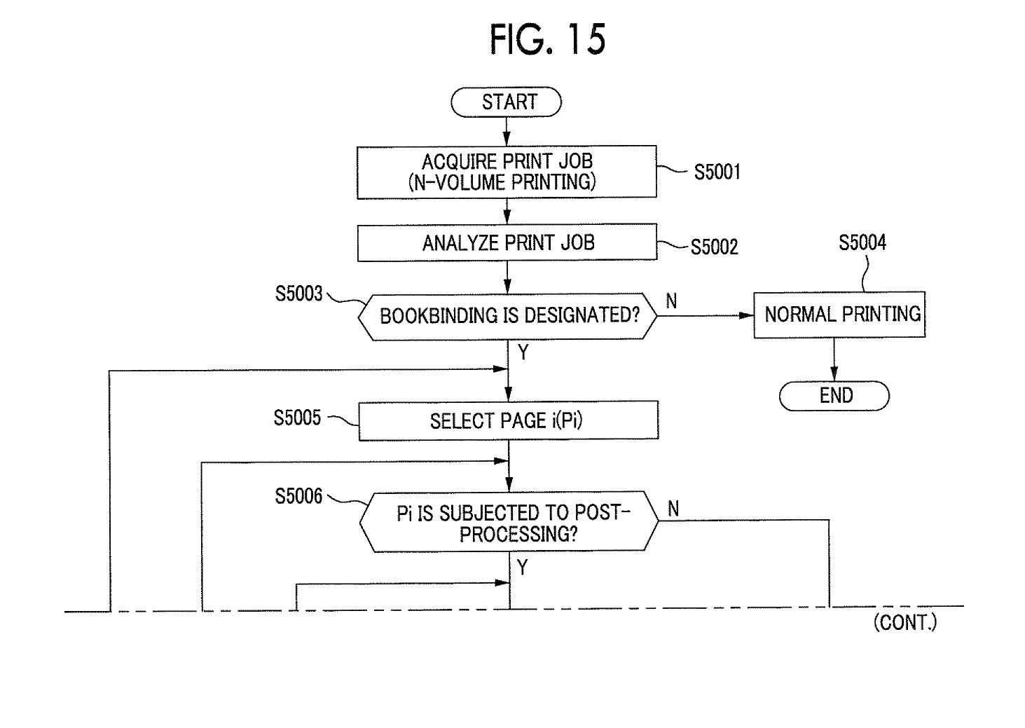

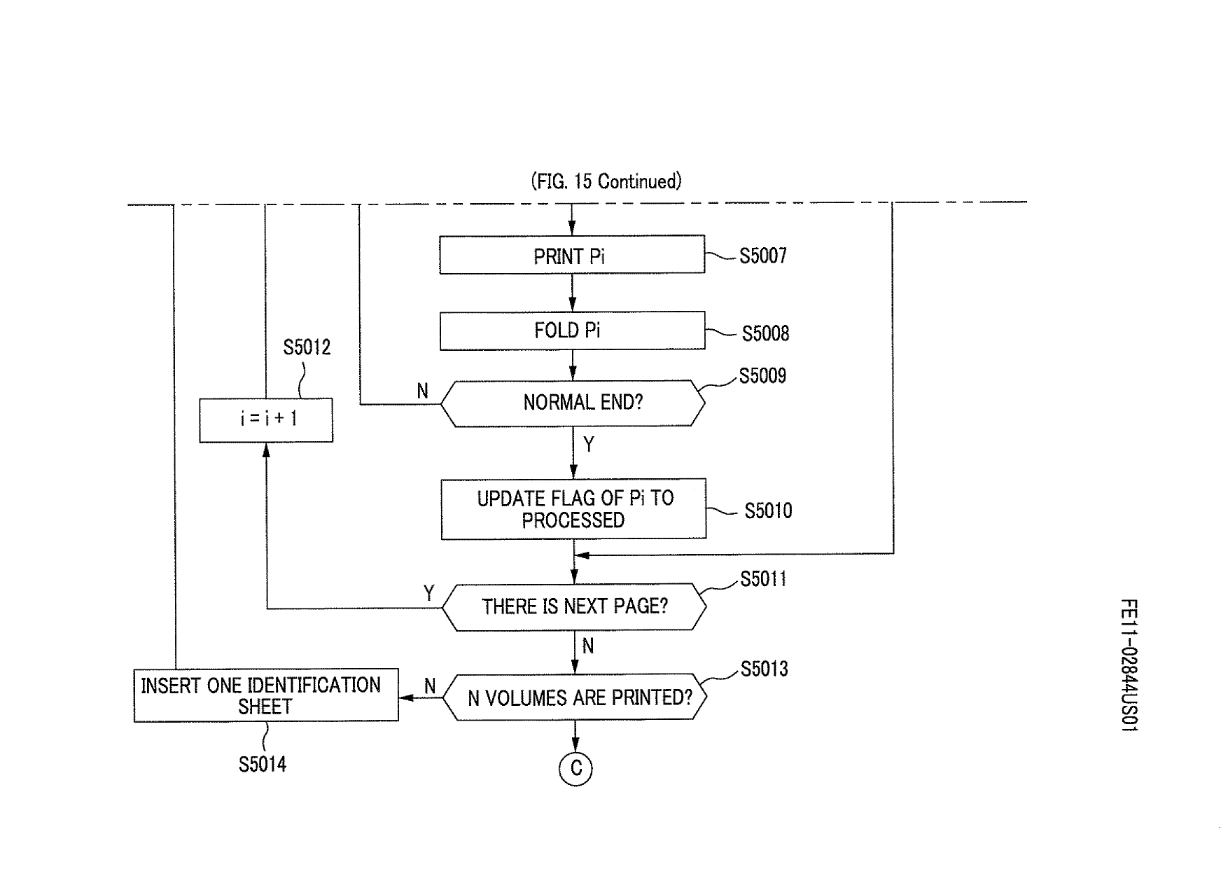

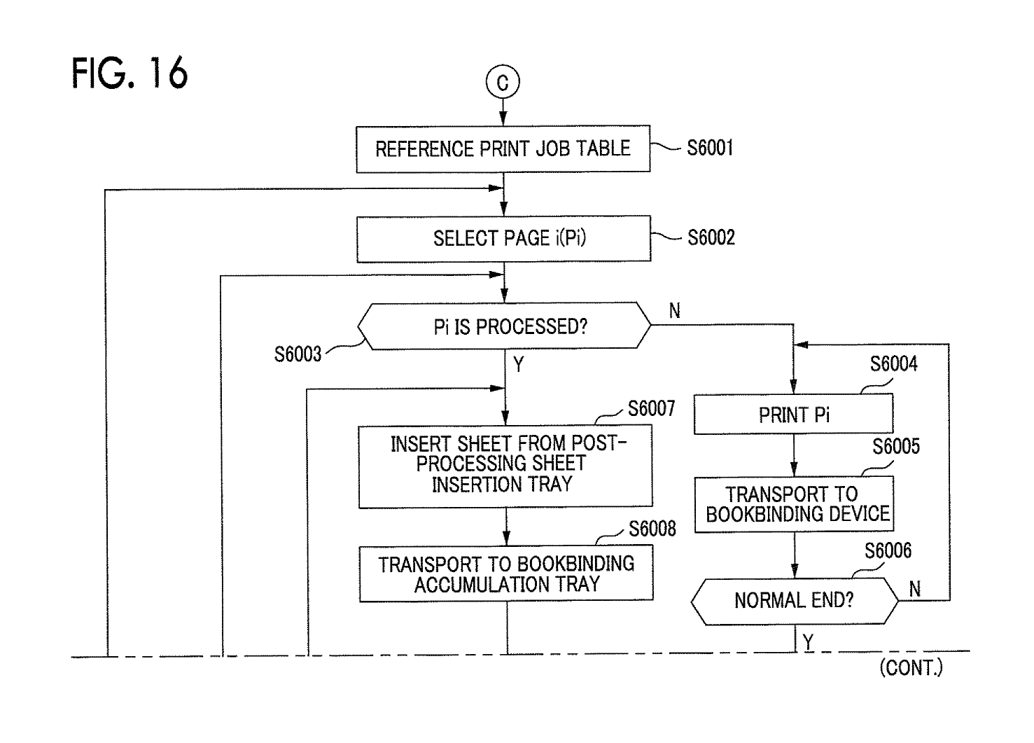

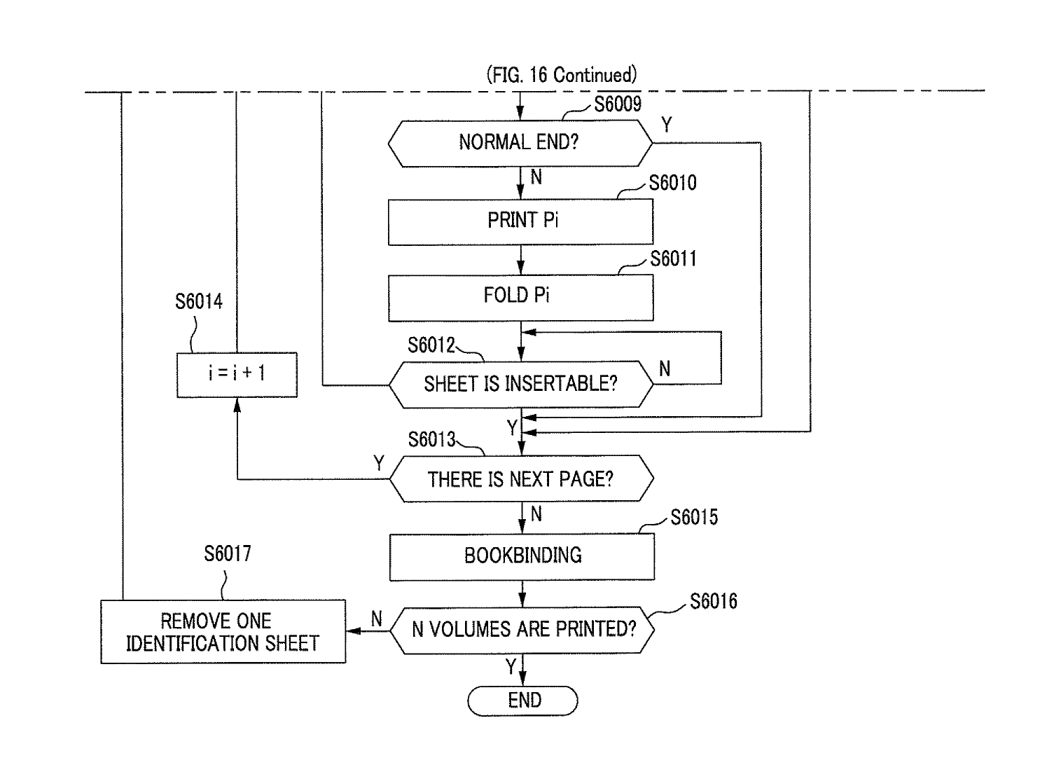

Next, the flow of bookbinding according to a third example in the bookbinding system 1 will be described with reference to flowcharts shown in FIGS. 15 and 16. In the third example, it is assumed that an instruction to bind multiple volumes is included in a print job. The third example relates to processing for binding N volumes, specifically, processing in which printing of post-processing necessary pages, post-processing, printing of post-processing unnecessary pages, and bookbinding are performed on the basis of a single print job.

As shown in FIG. 15, the printer 20 acquires a print job (including an instruction to output N volumes) from the client device 10 (S5001), and analyzes the acquired print job (S5002). For example, the printer 20 may acquire information, such as the presence/absence of bookbinding designation of the print job, the attribute (cover, presence/absence of Z folding designation, printing size, and the like) of each page printed on the basis of the print job, or RIP data of each page. The printer 20 may create a print job table representing the processing state of the print job shown in FIG. 10 on the basis of the analysis result in S5002, and may store the print job table in the memory 202 of the printer 20.

When no bookbinding is designated in the print job (S5003: N), the printer 20 executes normal printing (S5004), and ends the process. When bookbinding is designated in the print job (S5003: Y), the printer 20 executes the following processing.

The printer 20 selects a page Pi (where i is an integer of 1 to K, and the initial value of i is 1) which is printed on the basis of the print job (S5005). When Pi is to be post-processed (S5006: Y), the printer 20 prints Pi (S5007), and transports the printed Pi to the post-processing device 40.

The post-processing device 40 folds the transported Pi (S5008), and discharges the folded Pi to the post-processing output tray 410. When the processing result in S5008 is not a normal end (S5009: N), the post-processing device 40 returns to S5007. When the processing result in S5008 is a normal end (S5009: Y), for example, the processing completion flag of Pi in the print job table shown in FIG. 10 is updated to processed (T) (S5010).

When Pi is not to be post-processed (S5006: N), or after S5010, the printer 20 determines whether or not there is a next page to Pi (that is, whether or not i=K) (S5011), when there is a next page (S5011: Y), increments i (S5012), returns to S5006, and repeats the process after S5006. In S5011, when there is no next page (S5011: N), it is determined whether or not N volumes are printed (S5013). When N volumes are not printed (S5013: N), an identification sheet of size different from the post-processed sheet is inserted on the post-processed sheet output to the post-processing output tray 410 (S5014). When N volumes are printed (S5013: Y), an instruction to move N volumes of folded sheet bundles discharged to the post-processing output tray 410 of the post-processing device 40 to the post-processed sheet insertion tray 506 of the sheet feeding device 50 is given to the user, and the processing of the print job is paused. After N volumes of folded sheet bundles are disposed in the post-processed sheet insertion tray 506 by the user, if an input to restart the processing is received from the user, the printer 20 restarts the processing of the print job, and progresses to the flow of FIG. 16. As will be apparent from the flow shown in FIG. 15, before printing of the post-processing necessary pages, N volumes are output to the post-processing output tray 410 in a state where the post-processed sheets are collected for each volume of bookbinding.

As shown in FIG. 16, the printer 20 references the print job table (S6001), and selects the page Pi (where i is an integer of 1 to K, and the initial value of i is 1) (S6002).

When Pi in the print job table is not printed (S6003: N), the printer 20 prints Pi (S6004), and transports the printed Pi to the bookbinding device 30 (S6005). For example, if Pi is a cover, Pi may be transported to the tray 308 for a cover of the bookbinding device 30. When Pi is a folding unnecessary page, Pi may be transported to the accumulation tray 310 of the bookbinding device 30. When the processing result in S6004 and S6005 is not a normal end (S6006: N), the printer 20 returns to S6004, and performs the processing until the processing result becomes a normal end (S6006: Y).

Next, when Pi in the print job table is printed (S6003: Y), the printer 20 loads the sheets accumulated in the post-processed sheet insertion tray 506 of the sheet feeding device 50 one by one (S6007), and transports the loaded sheet to the accumulation tray 310 of the bookbinding device 30 (S6008). When the processing result in S6007 and S6008 is not a normal end (S6009: N), the printer 20 prints Pi (S6010), and transports the printed Pi to the post-processing device 40. The post-processing device 40 folds the transported Pi (S6011), and then discharges the folded Pi to the post-processing output tray 410. When Pi is not insertable from the post-processed sheet insertion tray 506 of the sheet feeding device 50 (S6012: N), the printer 20 stands by. When Pi is insertable (S6012: Y), the printer 20 returns to S6007. In S6012, the determination on whether or not Pi is insertable from the post-processed sheet insertion tray 506 may be made on the basis of an input from the user when the user receives an inquiry through the operation panel unit 214 of the printer 20, or may be made on the basis of the detection result of a sensor which is provided to detect the placement of a sheet in the post-processed sheet insertion tray 506.

When the processing result in S6004 and S6005 is a normal end (S6006: Y), or when the processing result in S6007 and S6008 is a normal end (S6009: Y), the printer 20 determines whether or not there is a next page to Pi (that is, whether or not i=K) (S6013), when there is a next page (S6013: Y), increments i (S6014), returns to S6003, and repeats the process after S6003. In S6013, when there is no next page (S6013: N), bookbinding is performed on the sheets accumulated in the bookbinding device 30 (S6015).

When N volumes are not bound (S6016: N), after one identification sheet is removed from the post-processed sheet insertion tray 506 (S6017), the printer 20 returns to S6002, and repeats the process after S6002. In S6016, when N volumes are bound (S6016: Y), the process ends.

In Example 3, since an identification sheet is inserted for each volume accumulated in the post-processed sheet insertion tray 506, when the identification sheet is erroneously transported to the bookbinding device instead of the post-processed sheets, in S6009, an error occurs and bookbinding is paused, thereby preventing a book of erroneous content from being generated since a volume break is deviated. Of course, in the third example, bookbinding of multiple volumes may be performed without inserting an identification sheet.

The invention is not limited to the foregoing exemplary embodiment. For example, although in the foregoing exemplary embodiment, an example where the transport paths are connected in order of the printer 20, the sheet feeding device 50, the bookbinding device 30, and the post-processing device 40 has been described, the transport paths may be connected in order of the printer 20, the post-processing device 40, the sheet feeding device 50, and the bookbinding device 30, or other devices (a punching device, a stapling device, a trimming device, and the like) may be connected between or before and after the printer 20, the sheet feeding device 50, the bookbinding device 30, and the post-processing device 40.

In the foregoing exemplary embodiment, the number of sheets to be transported from the sheet feeding device 50 may be counted, and when the number of sheets to be transported does not match the number of post-processing necessary pages in print data, control is performed so as not to execute bookbinding.

Although in this exemplary embodiment, an example where the invention is applied to when post-processing is Z folding has been described, the invention may be applied similarly to other kinds of processing in which a sheet after post-processing is unable to be transported directly to the bookbinding device 30.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A bookbinding control device comprising:
an acquisition unit that acquires print data including post-processing unnecessary pages requiring no post-processing after printing and before bookbinding and post-processing necessary pages requiring post-processing;
a printing controller that, after post-processed sheets on which post-processing is performed on sheets with the printed post-processing necessary pages are supplied to a sheet feed unit, prints the post-processing unnecessary pages in print data;
a first transport controller that performs control so as to transport sheets with the printed post-processing unnecessary pages to an accumulation unit of a bookbinding device with respect to the post-processing unnecessary pages in print data;
a second transport controller that performs control so as to transport the post-processed sheet supplied to the sheet feed unit to the accumulation unit of the bookbinding device with respect to the post-processing necessary pages in print data; and
a bookbinding controller that performs control so as to execute bookbinding on the sheets transported to the accumulation unit of the bookbinding device after printing based on print data ends.

2. The bookbinding control device according to claim 1,
wherein the printing controller performs control so as to execute printing of all post-processing necessary pages in print data and post-processing before printing of post-processing unnecessary pages in print data.

3. The bookbinding control device according to claim 2,
wherein the printing controller performs control so as to execute printing of all post-processing necessary pages in print data and post-processing before printing of post-processing unnecessary pages in print data, for designated volumes.

4. The bookbinding control device according to claim 1,
wherein, when the transport of the post-processed sheets to the accumulation unit of the bookbinding device fails, the printing controller pauses processing based on print data, re-executes printing and post-processing of a post-processing necessary page involved with the failure, and after a sheet as a result of the re-execution is supplied to the sheet feed unit, restarts the processing.

5. The bookbinding control device according to claim 2,
wherein, when the transport of the post-processed sheets to the accumulation unit of the bookbinding device fails, the printing controller pauses processing based on print data, re-executes printing and post-processing of a post-processing necessary page involved with the failure, and after a sheet as a result of the re-execution is supplied to the sheet feed unit, restarts the processing.

6. The bookbinding control device according to claim 3,
wherein, when the transport of the post-processed sheets to the accumulation unit of the bookbinding device fails, the printing controller pauses processing based on print data, re-executes printing and post-processing of a post-processing necessary page involved with the failure, and after a sheet as a result of the re-execution is supplied to the sheet feed unit, restarts the processing.

7. The bookbinding control device according to claim 1,
wherein the printing controller performs control so as to pause processing based on print data after printing of all post-processing necessary pages in print data and post-processing are executed, to restart the processing based on print data after post-processed sheets on which post-processing is executed on sheets with the printed post-processing necessary pages are supplied to the sheet feed unit, and to execute printing of post-processing unnecessary pages in print data.

8. The bookbinding control device according to claim 2,
wherein the printing controller performs control so as to pause processing based on print data after printing of all post-processing necessary pages in print data and post-processing are executed, to restart the processing based on print data after post-processed sheets on which post-processing is executed on sheets with the printed post-processing necessary pages are supplied to the sheet feed unit, and to execute printing of post-processing unnecessary pages in print data.

9. The bookbinding control device according to claim 3,
wherein the printing controller performs control so as to pause processing based on print data after printing of all post-processing necessary pages in print data and post-processing are executed, to restart the processing based on print data after post-processed sheets on which post-processing is executed on sheets with the printed post-processing necessary pages are supplied to the sheet feed unit, and to execute printing of post-processing unnecessary pages in print data.

10. The bookbinding control device according to claim 4,
wherein the printing controller performs control so as to pause processing based on print data after printing of all post-processing necessary pages in print data and post-processing are executed, to restart the processing based on print data after post-processed sheets on which post-processing is executed on sheets with the printed post-processing necessary pages are supplied to the sheet feed unit, and to execute printing of post-processing unnecessary pages in print data.

11. The bookbinding control device according to claim 5,
wherein the printing controller performs control so as to pause processing based on print data after printing of all post-processing necessary pages in print data and post-processing are executed, to restart the processing based on print data after post-processed sheets on which post-processing is executed on sheets with the printed post-processing necessary pages are supplied to the sheet feed unit, and to execute printing of post-processing unnecessary pages in print data.

12. The bookbinding control device according to claim 6,
wherein the printing controller performs control so as to pause processing based on print data after printing of all post-processing necessary pages in print data and post-processing are executed, to restart the processing based on print data after post-processed sheets on which post-processing is executed on sheets with the printed post-processing necessary pages are supplied to the sheet feed unit, and to execute printing of post-processing unnecessary pages in print data.

13. The bookbinding control device according to claim 1, further comprising:
a print data generation unit that ends the processing based on print data after printing of all post-processing necessary pages in print data and post-processing are executed, and generates new print data based on print data,
wherein the printing controller performs control so as to execute printing of the post-processing unnecessary pages in print data on the basis of new print data after the post-processed sheets on which post-processing is executed on the sheets with the printed post-processing necessary pages are supplied to the sheet feed unit.

14. The bookbinding control device according to claim 2, further comprising:
a print data generation unit that ends the processing based on print data after printing of all post-processing necessary pages in print data and post-processing are executed, and generates new print data based on print data,
wherein the printing controller performs control so as to execute printing of the post-processing unnecessary pages in print data on the basis of new print data after the post-processed sheets on which post-processing is executed on the sheets with the printed post-processing necessary pages are supplied to the sheet feed unit.

15. The bookbinding control device according to claim 3, further comprising:
a print data generation unit that ends the processing based on print data after printing of all post-processing necessary pages in print data and post-processing are executed, and generates new print data based on print data,
wherein the printing controller performs control so as to execute printing of the post-processing unnecessary pages in print data on the basis of new print data after the post-processed sheets on which post-processing is executed on the sheets with the printed post-processing necessary pages are supplied to the sheet feed unit.

16. The bookbinding control device according to claim 4, further comprising:
a print data generation unit that ends the processing based on print data after printing of all post-processing necessary pages in print data and post-processing are executed, and generates new print data based on print data,
wherein the printing controller performs control so as to execute printing of the post-processing unnecessary pages in print data on the basis of new print data after the post-processed sheets on which post-processing is executed on the sheets with the printed post-processing necessary pages are supplied to the sheet feed unit.

17. The bookbinding control device according to claim 5, further comprising:
a print data generation unit that ends the processing based on print data after printing of all post-processing necessary pages in print data and post-processing are executed, and generates new print data based on print data,
wherein the printing controller performs control so as to execute printing of the post-processing unnecessary pages in print data on the basis of new print data after the post-processed sheets on which post-processing is executed on the sheets with the printed post-processing necessary pages are supplied to the sheet feed unit.

18. A non-transitory computer readable medium storing a program causing a computer to function as:
an acquisition unit that acquires print data including post-processing unnecessary pages requiring no post-processing after printing and before bookbinding and post-processing necessary pages requiring post-processing;
a printing controller that, after post-processed sheets on which post-processing is performed on sheets with the printed post-processing necessary pages are supplied to a sheet feed unit, prints the post-processing unnecessary pages in print data;
a first transport controller that performs control so as to transport sheets with the printed post-processing unnecessary pages to an accumulation unit of a bookbinding device with respect to the post-processing unnecessary pages in print data;
a second transport controller that performs control so as to transport the post-processed sheet supplied to the sheet feed unit to the accumulation unit of the bookbinding device with respect to the post-processing necessary pages in print data; and
a bookbinding controller that performs control so as to execute bookbinding on the sheets transported to the accumulation unit of the bookbinding device after printing based on print data ends.

19. A bookbinding system comprising:
a printer;
a bookbinding device;
a post-processing device; and
a sheet feeding device,
wherein the printer includes
an acquisition unit that acquires print data including post-processing unnecessary pages requiring no post-processing after printing and before bookbinding and post-processing necessary pages requiring post-processing,
a printing controller that performs control so as to execute printing of the post-processing unnecessary pages in print data after post-processed sheets on which post-processing is executed by the post-processing device on sheets with the printed post-processing necessary pages are supplied to the sheet feeding device,
a first transport controller that performs control so as to transport sheets with the printed post-processing unnecessary pages to an accumulation unit of the bookbinding device with respect to the post-processing unnecessary pages in print data, and
a second transport controller that performs control so as to transport the post-processed sheets supplied to the sheet feeding device to the accumulation unit of the bookbinding device with respect to the post-processing necessary pages in print data, and
the bookbinding device includes
a bookbinding unit which performs bookbinding on sheets transported to the accumulation unit of the bookbinding device after printing based on print data ends.

20. A bookbinding control method comprising:
acquiring print data including post-processing unnecessary pages requiring no post-processing after printing and before bookbinding and post-processing necessary pages requiring post-processing;
after post-processed sheets on which post-processing is performed on sheets with the printed post-processing necessary pages are supplied to a sheet feed unit, printing the post-processing unnecessary pages in print data;
performing control so as to transport sheets with the printed post-processing unnecessary pages to an accumulation unit of a bookbinding device with respect to the post-processing unnecessary pages in print data;
performing control so as to transport the post-processed sheet supplied to the sheet feed unit to the accumulation unit of the bookbinding device with respect to the post-processing necessary pages in print data; and
performing control so as to execute bookbinding on the sheets transported to the accumulation unit of the bookbinding device after printing based on print data ends.
